(19) United States
(12) Patent Application Publication
(10) Pub. No.: US 2017/0328590 A1
(43) Pub. Date: Nov. 16, 2017

(54) PARALLEL AIR FILTRATION

(71) Applicant: KONINKLIJKE PHILIPS N.V., EINDHOVEN (NL)

(72) Inventors: RUI KE, EINDHOVEN (NL); NARENDRA NILKANTH PAWAR, EINDHOVEN (NL); DECLAN PATRICK KELLY, EINDHOVEN (NL); JOANNE TANG, EINDHOVEN (NL); RUIFENG XUE, EINDHOVEN (NL)

(21) Appl. No.: 15/535,548

(22) PCT Filed: Dec. 18, 2015
(86) PCT No.: PCT/EP2015/080680

§ 371 Date: Jun. 13, 2017

(30) Foreign Application Priority Data
Dec. 19, 2014 (CN) PCT/CN2014/094408
Jan. 30, 2015 (EP) 15153270.2

(51) Int. Cl. F24F 3/16; B01D 46/44; B01D 46/46; F24F 11/00; B01D 46/00

(52) U.S. Cl. CPC F24F 3/1603; B01D 46/0041; B01D 46/442; B01D 46/46; F24F 11/0078; F24F 11/0017; B01D 46/002; F24F 11/0079; B01D 2267/40; B01D 2273/30; F24F 2011/0023; F24F 2011/0093; B01D 2279/40

(57) ABSTRACT

In various embodiments, an air purification system (100, 300, 400) may include a first air filter (316, 416) that targets at least a first type of pollutant. In various embodiments, air that passes through the first air filter may be unobstructed by other air filters. In various embodiments, a second air filter (316, 416) may target at least a second type of pollutant that is different than the first type of pollutant. In various embodiments, air that passes through the second air filter may also be unobstructed by other air filters. In various embodiments, a controller (102, 302) may be configured to selectively move the first and/or second air filters to expose one or both of the first and second air filters to one or more air streams, e.g., based on user input and/or on one or more signals from one or more pollutant sensors (106, 306).

### FIELD OF THE INVENTION

The present invention is directed generally to air purification. More particularly, various inventive methods and apparatus disclosed herein relate to purifying air with multiple filters of different types in parallel.

### BACKGROUND OF THE INVENTION

Different pollutants may be present in different environments. For instance, a new home may have less particle pollution than an older home. A laboratory may have more chemical pollutants than a private home. Existing air purifiers are typically manufactured uniformly. An air purifier may include multiple air filters, each targeting one or more pollutants. However, the same air filters may be selected by the manufacturer regardless of the environmental conditions in which the air purifier is ultimately deployed. In addition, air filters are typically arranged in series, one after another. Each filter may cause a drop air pressure which affects a clean air delivery rate (“CADR”) of the filters. These pressure drops, particularly in the aggregate, may require additional power consumption to overcome, which in turn may create unwanted noise pollution.

It is known from JP2006136808 to provide an air purifier having upper and lower filters with upper and lower blowers, respectively. The upper and lower blower may each be controlled independently depending upon a detected level of contamination of the air being filtered.

### SUMMARY OF THE INVENTION

The present disclosure is directed to inventive methods and apparatus for air purification. In various embodiments, an air purification system may include: a first air filter that targets at least a first type of pollutant, wherein air that passes through the first air filter is unobstructed by other air filters; a second air filter that targets at least a second type of pollutant that is different than the first type of pollutant, wherein air that passes through the second air filter is unobstructed by other air filters; and a controller configured to selectively move the first and/or second air filters to expose one or both of the first and second air filters to one or more air streams.

In various embodiments, the controller may be configured to selectively block the first and second air filters from one or more air streams. In various embodiments, the air purification system may further include a first set of louvers adjacent the first air filter and a second set of louvers adjacent the second air filter. The controller may be configured to operate the first and second sets of louvers to selectively expose the first and second air filters to one or more air streams.

In various embodiments, the controller may further be configured to selectively alter one or more air streams to selectively expose the first and second air filters to one or more air streams. In various versions, the air purification system may further include at least one fan operably coupled with the controller. The controller may be configured to selectively operate the at least one fan to selectively expose the first or second air filter to one or more air streams. In various versions, the air purification system may include a first fan adjacent the first air filter and a second fan adjacent the second air filter. The first and second fans may be operably coupled with the controller. The controller may be configured to selectively operate the first and second fans to selectively expose the first and second air filters to one or more air streams.

In various versions, the first air filter may be part of a first set of air filters forming a first filter assembly, and the second air filter may be part of a second set of air filters forming a second filter assembly. In various versions, the controller may be configured to move the first filter assembly to selectively expose one of the first set of air filters to an air stream. In various versions, the first set of air filters may be positioned about an axis of rotation of the first filter assembly. The controller may be configured to rotate the first filter assembly about the axis of rotation to selectively expose one of the first set of air filters to the air stream.

In various embodiments, the controller may be further configured to: track an amount of time the first air filter is exposed to one or more air streams; and provide output notifying a user that the first air filter is near or has reached an end of its useful life based on a determination that the amount of time satisfies a threshold.

In various embodiments, the air purification system may further include a pollutant sensor to provide a signal indicative of a detected pollutant. The controller may be configured to selectively expose one or both of the first and second air filters to one or more air streams based at least in part on the signal. In various versions, the pollutant sensor may be positioned downstream of the first air filter and is configured to detect presence of the second type of pollutant.

In another aspect, the first air filter comprises a first set of air filters, each adapted to detect a different pollutant, the first air filter being movable to expose a single one of the air filters of the first set of air filters to one or more air streams; and the second filter comprises a second set of air filters, each adapted to detect a different pollutant. The second air filter being movable to expose a single one of the air filters of the second set of air filters to one or more air streams in parallel to the single exposed air filter of the first set.

In another aspect, a method of purifying air may include: selectively exposing, by a controller, a first air filter to one or more air streams to target at least a first pollutant; and selectively exposing, by the controller, a second air filter to one or more air streams in parallel with the first filter to target at least a second pollutant that is different than the first pollutant. Air that passes through the first and second air filters may be unobstructed by other air filters and one or both of the first and second filters is selectively exposed by the controller to one or more air streams by moving the first and/or second air filter.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic depiction of an air purification system, in accordance with various embodiments.

FIG. 2 is a schematic depiction of an example filter assembly of an example air purification system, in accordance with various embodiments.

FIG. 3 is a schematic depiction of another example air purification system, in accordance with various embodiments.

FIG. 4 depicts an example filter assembly for use in various air purification systems, in accordance with various embodiments.

FIGS. 5A-C depict example configurations of a plurality of filter assemblies of an air purification system, in accordance with various embodiments.

FIGS. 6A-B depict examples of how air filters may be selectively exposed to air streams across a time interval, in accordance with various embodiments.

FIG. 7 depicts an example method for purifying air, in accordance with various embodiments.

### DETAILED DESCRIPTION OF THE EMBODIMENTS

Different pollutants may be present in different environments. For instance, a new home may have less particle pollution than an older home, but may have more gas pollutants such as formaldehyde due to new decorations/material used in furniture. A laboratory may have more chemical pollutants than a private home. Existing air purifiers are typically manufactured uniformly. An air purifier may include multiple air filters, each targeting one or more pollutants. However, the same air filters may be selected by the manufacturer regardless of the environmental conditions in which the air purifier is ultimately deployed. In addition, air filters are typically arranged in series, one after another. Each filter may cause a drop air pressure which affects a clean air delivery rate (“CADR”) of the filters. These pressure drops, particularly in the aggregate, may require additional power consumption to overcome, which in turn may create unwanted noise pollution.

Thus, Applicants have recognized a need in the art to enable customization of air purification systems based on different types pollutants present in a given environment. More generally, Applicants have recognized and appreciated that it would be beneficial to provide an air purification system that can be adapted, or even automatically adapts, to different environments with different pollutants. In view of the foregoing, various embodiments and implementations of the present invention are directed to air purification systems in which multiple air filters that target various types of pollutants are selectively exposable to one or more air streams.

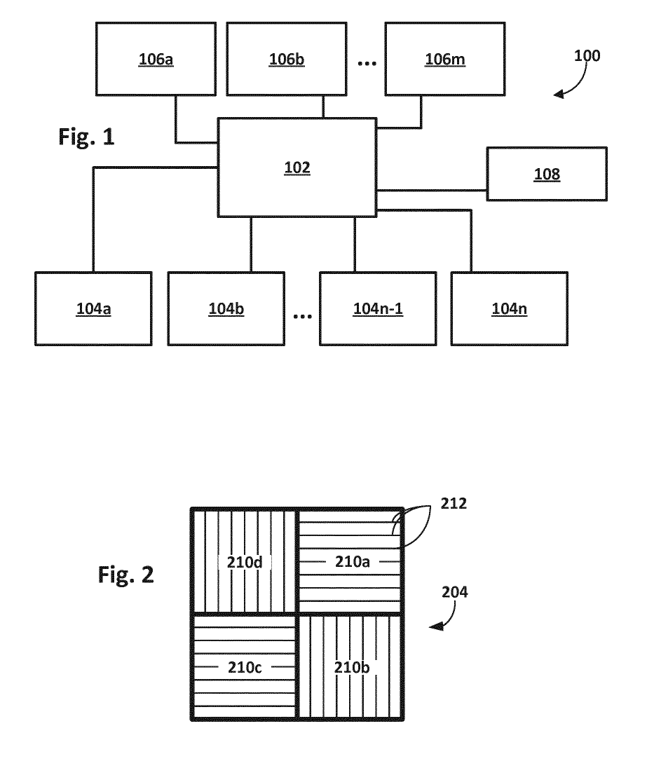

FIG. 1 is a schematic depiction of an air purification system 100 configured with selected aspects of the present disclosure. Air purification system 100 may include a controller 102, one or more air filter assemblies 104a-n (generically referred to as “air filter assemblies 104”), and zero or more pollutant sensors 106a-m (generically referred to as “pollutant sensors 106”). Controller 102 may be operably and/or communicative coupled with, and thus configured to receive signals from, one or more pollutant sensors 106a-m and/or a user input 108. User input 108 may take various forms, including but not limited to a keyboard, a mouse, a microphone, a touch screen, one or more dipswitches, one or more buttons, one or more knobs, and so forth. In other embodiments, user input 108 may be implemented on a separate device, such as a smart phone or tablet computer operating an application, or “app,” that provides a user with various controls (e.g., rendered on a touch screen). In such embodiments, user commands may be transmitted to controller 102, e.g., using one or more wired or wireless networks (e.g., BlueTooth, Wi-Fi, etc.). Controller 102 may also be operably and/or communicative coupled with, and therefore configured to operate, one or more air filter assemblies 104. In some embodiments, controller 102 may operate filter assemblies 104 based on one or more signals from pollutant sensors 106 and/or user input 108. In various embodiments, controller 102 may operate various mechanical features of filter assemblies 104 (e.g., louvers, fans, rotating filter assemblies, etc.) using various drive mechanisms (not depicted), such as one or more motors.

In various embodiments, controller 102 may come in the form of various apparatus relating to the operation of one or more components, such as air filter assemblies 104. Controller 102 may be implemented in numerous ways, such as with dedicated hardware, software, or any combination of the two, to perform various functions discussed herein. In some embodiments, controller 102 may be integral to an air purifier product that houses most or all of air purification system 100. A “processor” is one example of a controller which employs one or more microprocessors that may be programmed using software (e.g., microcode) to perform various functions discussed herein. Controller 102 may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs). In some embodiments, controller 102 may be separate from a housing that includes most or all of air purification system 100. For example, in some embodiments, controller 102 may be software executing on one or more remote computing devices, such as smart phones, tablets, or one or more servers operating a “cloud.”

Additionally or alternatively, in some embodiments, air filter assemblies 104 may be manually controllable, e.g., using one or more levers, buttons, knobs, and so forth. In various embodiments described herein, controller 102 may be operably and/or communicatively coupled with other components, such as air filter assemblies 104, fans (not depicted in FIG. 1), pollutant sensors 106, user input 108, other output devices (not depicted), and so forth, using various wired and/or wireless technologies. In some embodiments, wireless technology such as BlueTooth, Wi-Fi, cellular, RFID, NFC, and other similar technologies may be employed. In other embodiments, wired technology such as wire buses, Ethernet, and so forth, may be employed.

Each pollutant sensor 106 may be configured to detect presence of one or more pollutants, including but not limited to various types of particles (e.g., dust, pet hair, dander, etc.), various types of chemicals (e.g., volatile organic compounds, or “VOCs,” formaldehyde, BTX, etc.), and so forth. The particles that may be detected may have various sizes, such as PM 2.5, PM 10, ultra-fine particles with <PM 1, and so forth. Pollutant sensors 106 may be integral with air purification system 100, or may be separate therefrom. For instance, in some embodiments, a pollutant sensor 106 may include an air quality index (“AQI”) sensor that either detects and determines an AQI itself, or that receives AQI information from an outside source, such as a web service.

In various embodiments, a pollutant sensor 106 may be configured to provide a signal to controller 102. In some embodiments, the signal may be a binary signal indicative of presence/no presence of a particular pollutant, a signal indicative of presence of a pollutant in an amount that satisfies a threshold, a signal indicative of an amount of a pollutant detected in an environment, and so forth. In some embodiments, controller 102 may be configured to expose one or more air filters of filter assemblies 104a-n to one or more air streams if pollutants the respective air filters target are detected. In some embodiments, controller 102 (or pollutant sensor 106 itself) may be configured to compare the amount of pollutant detected to one or more pollutant thresholds. If a pollutant threshold is satisfied, controller 102 may expose one or more air filters to one or more air streams. Additionally or alternatively, and as will be described below, controller 102 may selectively expose one or more air filters to one or more air streams for varying time intervals, depending on, among other things, amounts of one or more pollutants detected by pollutant sensors 106 in an environment.

One or more pollutant thresholds may be selected based on whether the cost of filtering the pollutant (e.g., extra power consumption, wear and tear on air filter) is outweighed by the benefit of removing or reducing presence of the pollutant. In some instances, the thresholds may be selected as those that are defined as “safe,” e.g. in government standards. Other, sometimes multiple thresholds may be selected based on particular sensitivities, such as asthmatics being present. Additionally or alternatively, the thresholds may be selected by a consumer.

Each filter assembly 104 may include a set of one or more air filters (not depicted in FIG. 1). Various types of air filters (such as carbon filters or HEPA filters) may target various pollutants, including but not limited to various types of particles (e.g., dust, pet hair, dander, etc.) and various types of chemicals (e.g., volatile organic compounds, or “VOCs,” formaldehyde, BTX, etc.). In some instances, a single air filter may target multiple types of pollutants, and may be referred to as a “hybrid” filter. Other air filters may target a single pollutant, or a single type of pollutant. In some embodiments, two or more air filters may each target multiple pollutants, and pollutants targeted by one air filter may overlap or not overlap pollutants targeted by the other air filter. Air filters may take various cross-sectional shapes, including planar, convex, concave, corrugated, and so forth. Air filters may have various thicknesses depending on various factors, such as how many pollutants the air filters target, the nature of the pollutants the air filters target, and so forth.

Each filter assembly 104 may additionally include various mechanical structure, not depicted in FIG. 1, associated with one or more air filters. As will be described herein, in various embodiments, one or more air filters and/or the associated mechanical structure may be physically alterable and/or movable to selectively expose one or more air filters to one or more air streams. Additionally or alternatively, in some embodiments, each filter assembly 104 may include various devices (not depicted in FIG. 1) to create and/or maintain one or more air streams, such as one or more fans. In various embodiments, these air stream creators or maintainers may be selectively and/or individually operated, e.g., by controller 102, to selectively expose one or more air filters to one or more air streams.

An air filter of each filter assembly 104 may be exposed, e.g., by controller 102, to one or more air streams in parallel with air filters of other filter assemblies 104, as opposed to in series. Moreover, in various embodiments, each air filter, when exposed to one or more air streams, may be unobstructed by other air filters, avoiding series of air filters altogether. This may improve a CADR of air purification system 100. CADR may be determined based on multiplication of air flow through an air filter, Φ, and one-pass filter efficiency η. Utilizing air filters in parallel rather than in series may enable more functional materials to be loaded onto various types of air filters, which may increase air filter efficiency η as a result. Utilizing air filters in parallel may also provide more freedom to tune the airflow Φ individually for different pollutants in response to real air conditions detected by one or more pollutant sensors 106. Further, exposing air filters to air streams only as needed, instead of universally, may increase a useful lifetime of the air filters.

FIG. 2 schematically depicts one embodiment in which an air filter assembly 204 includes four panes, 210a-d, which respectively cover or obstruct four different air filters (not visible behind panes 210). Each pane 210 includes a set of louvers 212 (e.g., blinds) that may be operable, e.g., by controller 102, to be collectively opened or closed, effectively blocking or not blocking the adjacent air filter behind the respective pane 210. While a particular number of louvers 212 are depicted in front of each pane 210 in FIG. 2, this is not meant to be limiting. More or less louvers 212 may be deployed in front of a single pane 210, and in some embodiments, different numbers of louvers 212 may be deployed in front of different panes 210.

An air stream in FIG. 2 may pass into the page (or out of the page) through whichever panes 210 in which louvers 212 are opened. Suppose it is desired that an air filter behind first pane 210a and an air filter behind third pane 210c be employed to target pollutants, and that air filters behind second and fourth panes 210b and 210d not be used. Louvers 212 of first pane 210a and third pane 210c may be opened, exposing their respective air filters to the air stream. Louvers 212 of second pane 210b and fourth pane 210d may be closed, effectively obstructing the air stream. In some embodiments, louvers 212 in different panes 210 may be opened (or closed) to various degrees, so that air may pass more easily through one pane 210 than another. As will be described below, louvers 212 may also be selectively opened/closed across one or more time intervals to selectively expose respective filters to an air stream for desired sub time intervals.

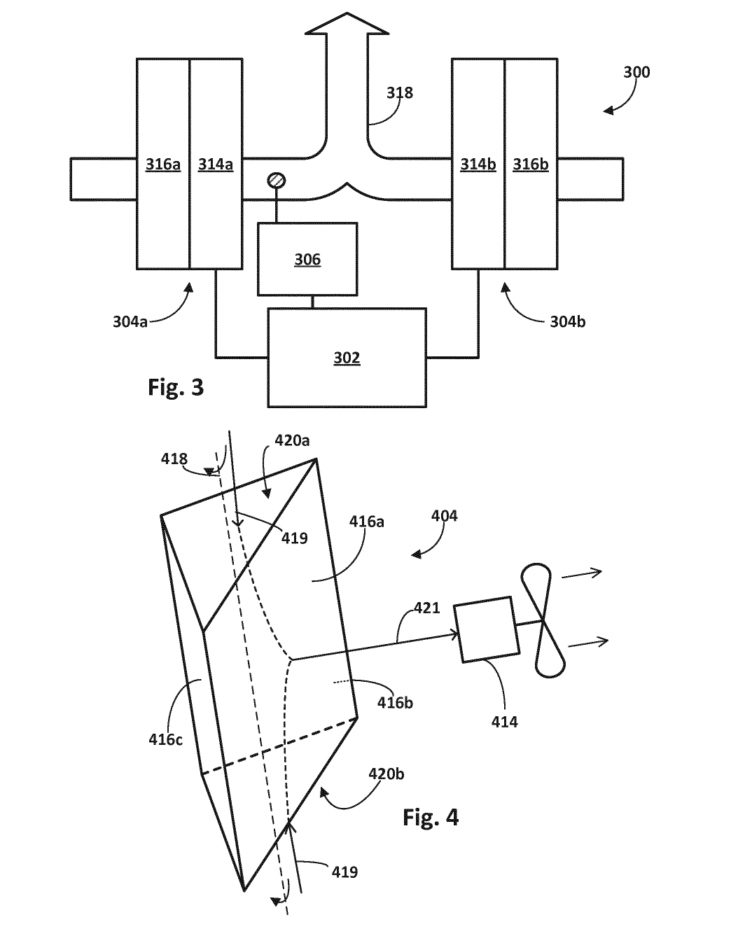

FIG. 3 depicts another example air purification system 300, in accordance with various embodiments. Air purification system 300 may include two filter assemblies, 304a and 304b. In other similar embodiments, more or less filter assemblies 304 may be provided. A controller 302 may be operably and/or communicatively coupled with air filter assemblies 304 and/or one or more pollutant sensors 306. Filter assemblies 304a and 304b may include, respectively, fans 314a and 314b, as well as air filters 316a and 316b adjacent to fans 314a and 314b, respectively.

In various embodiments, controller 302 may be configured to selectively operate fans 314a and 314b to selectively expose respective air filters 316a and 316b to air flows 318. In this example, a single, effluent combined air stream 318 is merged from two influent air streams passing through each fan 314. However, this is not required, and in other embodiments, air purified air passing through filters 316 may be delivered downstream separately (e.g., in parallel). Also in this example, the merged air stream 318 may be drawn toward the top of the page by various mechanisms (not depicted), such as another fan. However, this is not meant to be limiting. Other configurations with filter assemblies similar to those depicted in FIG. 3 used in separate air passages may be employed. As another example, one or more blocking mechanisms, such as louvers similar to those depicted in FIG. 2, may be employed in combination with selectively-operable fans such as fans 314 depicted in FIG. 3.

Controller 302 may individually operate fans 314a and 314b at various speeds, depending on the circumstances. For example, one fan may be operated at full speed, while the other fan may be operated at less than full speed, or even not operated. Similarly, controller 302 may operate both fans 314 at full speed should the situation warrant it. In some embodiments, controller 302 may be configured to selectively operate fans 314a and 314b based on one or more signals from pollutant sensor 306.

In the example of FIG. 3, pollutant sensor 306 is positioned downstream of air filter 316a, and may be configured to detect a type of pollutant that second filter 316b targets. This may facilitate more accurate pollutant detection. Suppose second filter 316b targets formaldehyde, and that first air filter 316a targets particles of a particular size. Air passing through first air filter 316a may be substantially free of these particles, which may make it easier for pollutant sensor 306 to detect the presence of formaldehyde without the “poisoning” created by co-existing particle pollutants. However, in other embodiments, pollutant sensors 306 may be placed elsewhere, such as upstream of either fan 314, or even outside of air purification system 300, e.g., somewhere else in an environment in which system 300 is deployed.

In the example of FIG. 3, it may be possible to utilize air filters 316 that might not be practicable in traditional series filter layouts. For example, a much thicker air filter may be employed, which may enable more functional materials to be included in the air filter, in turn improving its pollutant removal functionality without dramatically increasing its resistance to air flow. For instance, an air filter 316 targeting a particular chemical such as formaldehyde may be made thicker and yet more porous, so that it captures (or otherwise renders benign—for instance, some filters may break down hazardous pollutants into less hazardous, sometimes simpler pollutants) a greater amount of chemical without decreasing CADR unacceptably. Also, it may be desirable to filter particles or certain gases first before activating a second air flow and air filter. For example, a photocatalytic oxidation (“PCO”) filter may remove gases but may be vulnerable from poisoning caused by particles and/or certain gases. Thus, it may be possible to first selectively expose another filter (e.g., particle) first to remove certain pollutants from the air, before exposing a PCO filter to one or more air streams.

In some embodiments, a single fan may be employed to selectively expose two or more air filters to one or more air streams. Suppose two air filters of an air purification system are positioned in parallel, each along a separate air pathway, and that a single fan is in air communication with both air pathways. Suppose further that a first of the air pathways has a higher air resistance than a second (e.g., because it is narrower, or because the filter will only permit passage of air of sufficient strength) such that air will only flow through the first pathway if the air stream created by the single fan surpasses a particular speed. In such an embodiment, a first fan setting (e.g., slow) could be used to selectively expose just the second filter in the second air pathway to an air stream, and a second fan setting (e.g., high) could be used to selectively expose both the first and second air filters to air streams.

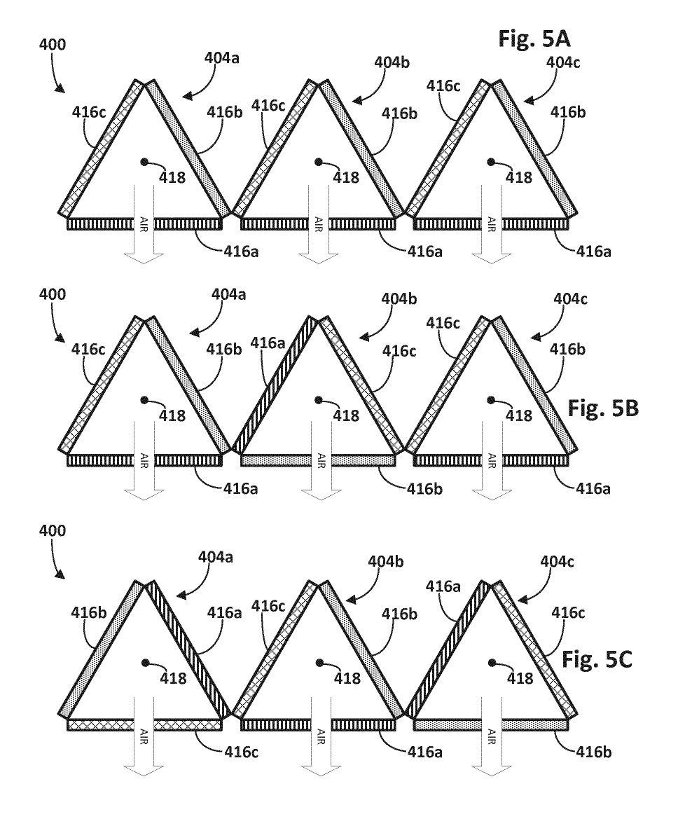

In some embodiments, entire or portions of filter assemblies may be selectively moveable to expose one or more air filters to one or more air streams. Referring to FIG. 4, a filter assembly 404 that may form part of an air purification system (not indicated in FIG. 4, see FIG. 5) includes a set of three filters, 416a, 416b and 416c. In some embodiments, each air filter of the set of filters may target at least one pollutant that is different from pollutants targeted by the other air filters, though this is not required. Air filters 416a-c may be positioned about an axis of rotation 418 of filter assembly 404. One or more air streams 419 may enter an interior of filter assembly 404 through top and bottom openings 420a and 420b, respectively. A fan 414 may be positioned outside of filter assembly 404 and may be selectively operated, e.g., by a controller (not depicted in FIG. 4), to create a downstream air stream 421 from an interior of filter assembly 404 through a facing air filter 416 towards fan 414, as shown. The controller may be further configured to rotate filter assembly 404 about axis of rotation 418 to selectively expose one of the first set of filters to downstream air stream 421 created by fan 414.

FIGS. 5A-C depict, in various states of operation, an air purification system 400 that includes three filter assemblies 404a-c, each like that depicted in FIG. 4, operating in parallel. In FIG. 5A, each filter assembly 404a-c is rotated about its respective axis of rotation 418 in the same manner, so that a first filter 416a is exposed to a respective air stream (represented by the downward arrows). In this configuration, the pollutant(s) that first filter 416a is designed to capture or otherwise render benign may be 100% targeted, and may be captured or rendered benign to a relatively high degree. Pollutants that second and third filters 416b and 416c are designed to capture or render benign may not be targeted and/or captured at all.

In FIG. 5B, the center filter assembly 404b has been rotated clockwise about its axis 418 so that second filter 416b is now exposed to an air stream passing through an interior of center filter assembly 404b. Left and right filter assemblies 404a and 404b have not been rotated, so that their respective first filters 416a are still exposed to their respective air streams. The configuration of filter assemblies 404a-c shown in FIG. 5B may aim to capture or otherwise render benign approximately 33% of the pollutant second air filter 416b targets, and may capture or render benign approximately 67% of the pollutant that first air filter 416a targets.

In FIG. 5C, filter assemblies 404a-c are rotated about their respective axes of rotation 418 to expose different air filters on each filter assembly 404 to a respective air stream. Third air filter 416c of left filter assembly 404a is exposed to a respective air stream. First air filter 416a of center filter assembly 404b is exposed to a respective air stream. And second air filter 416b of right filter assembly 404c is exposed to a respective air stream. The configuration of filter assemblies 404a-c shown in FIG. 5C may capture or render benign approximately 33% each of the pollutants that first, second and third filters 416a-c target.

The filter assembly 404 depicted in FIG. 4, as well as the filter assemblies 404a-c depicted in FIGS. 5A-C, have triangular cross sections. However, this is not meant to be limiting. In various embodiments, similar filter assemblies may have other cross-sectional shapes, depending on, among other things, the number of filters used, size constraints, and so forth. For example, the three air filters 416a-c shown on each filter assembly 404 could instead be mounted to form three sides of a rectangular (including square) cross section. Moreover, air filters need not be flat necessarily, and a filter assembly could include two or more curved air filters mounted to a filter assembly so that in cross section, each filter forms an arc of a circular or elliptical cross section.

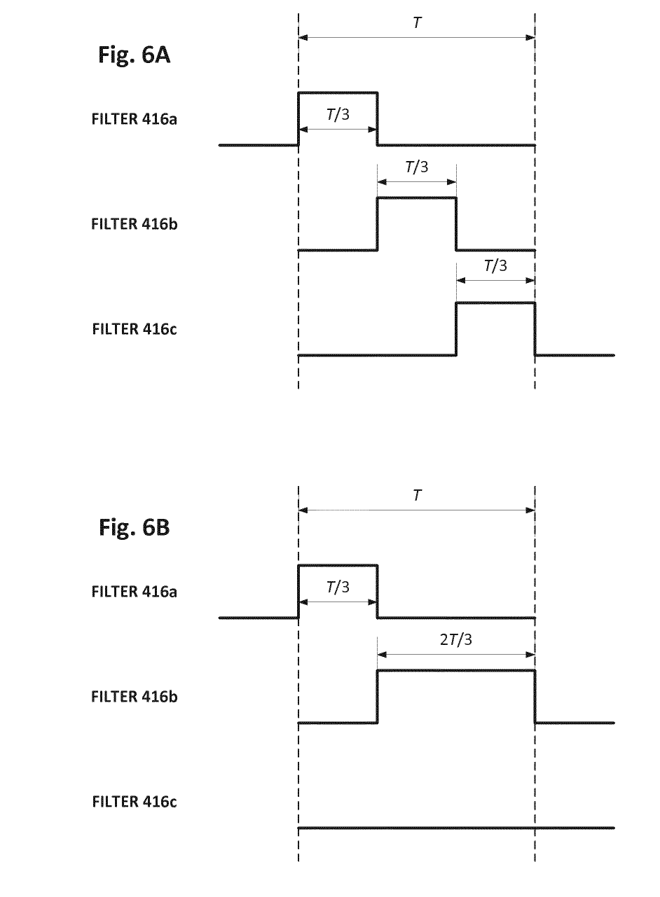

The filter assembly configurations depicted in FIGS. 5A-C may be maintained for various time intervals depending on various factors, including but not limited to pollutants detected (e.g., by pollutant sensor 106) in the environment in which air purification system 400 is deployed. FIGS. 6A-B depict a non-limiting example of how filters 416a-c of one filter assembly 404 may be selectively and transiently exposed to one or more air streams within a particular time interval, T. When the line for each filter 416 is “high,” the filter assembly 404 of which the respective filter 416 is part is rotated so that the respective filter 416 is being exposed to one or more air streams. When the line for each filter 416 is “low,” the filter assembly 404 of which the respective filter 416 is part has been rotated so that the respective filter 416 is not being exposed to one or more air streams. In a system such as air purification system 400 of FIG. 5, in which multiple filter assemblies 404 are deployed, similar or different filter timing exposition schemes may be employed by each filter assembly 404.

In FIG. 6A, first filter 416a, second filter 416b, and third filter 416c are each exposed to one or more air streams for one third (T/3) of the time interval T. This scheme may be employed, for instance, in a scenario in which the pollutants that each of the filters targets are detected in the environment in which air purification system 400 is employed in amounts sufficient to satisfy one or more thresholds. In FIG. 6B, first filter 416a is exposed to one or more air streams for one third (T/3) of the time interval T. Second filter 416b is then applied for two thirds (2T/3) of the time interval T. Third filter 416c is not exposed to any air streams. The timing scheme of FIG. 6B may be employed, for instance, where pollutants that first filter 416a and second filter 416b target are detected in an environment in sufficient amounts to satisfy one or more thresholds, but where a pollutant(s) that third filter 416c target are not detected, or are detected in amounts that fail to satisfy a minimum threshold.

While the air filter exposure timing schemes depicted in FIGS. 6A-B are described as being applicable to the air purification system 400 depicted in FIGS. 4-5, this is not meant to be limiting. Other embodiments described herein may also be operated in accordance with similar timing schemes. For example, in FIG. 2, louvers 212 of a particular pane 210 could be opened for a first time interval and closed for a second time interval. A ratio between the first and second time intervals could reflect a detected amount of a pollutant a respective air filter targets. Louvers 212 of another pane 210 could similarly be opened or closed for various time intervals, e.g., selected based on a detected amount of another pollutant. As another example, the various fans 314a-b of FIG. 3 could be selectively operated for various time intervals to account for detected amounts of various pollutants.

In various embodiments, a controller such as controller 102 in FIG. 1 may be configured to track the time for which each filter is exposed to one or more air streams. Based on an accumulation of these exposure times, the controller may be configured to provide an audible and/or visual output notifying the user when an end of useful life of a particular filter is near or has been reached. For example, suppose a formaldehyde filter has been exposed to air streams repeatedly over a long period of time, such that the cumulative amount of time it has been exposed approaches, matches or exceeds its useful life. The controller may be configured to cause warnings (audio or visual) to be output to a user, e.g., soon before the end of the filter's useful life, at the end of its useful life, and/or after the end of its useful life.

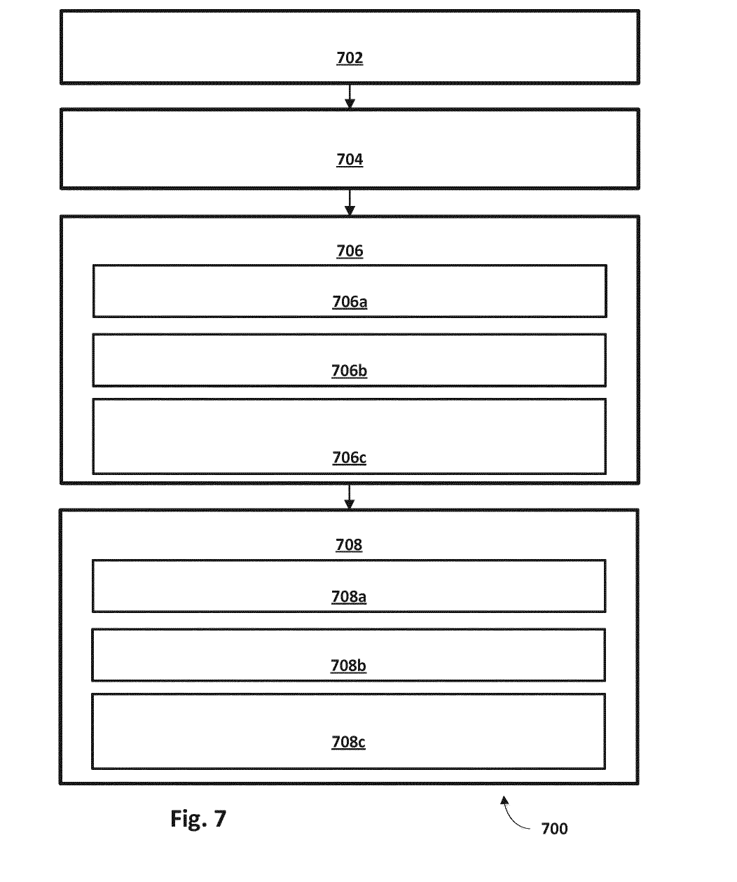

FIG. 7 depicts an example method 700 for purifying air, in accordance with various embodiments. One or more operations depicted in FIG. 7 may be performed manually, e.g., using user input 108, and/or may be performed by various components described herein, such as controller 102 in FIG. 1, one or more pollutant sensors (e.g., 106a-m in FIG. 1), etc. At block 702, a first signal may be received from a first pollutant sensor. The first pollutant sensor may be adapted to detect presence of a first pollutant, and so the first signal may be indicative of an amount of the first pollutant that is present in an environment. Similarly, at block 704, a second signal may be received from a second pollutant sensor. The second pollutant sensor may be adapted to detect presence of a second pollutant, and so the second signal may be indicative of an amount of the second pollutant that is present in the environment.

At block 706, a first air filter targeting the first pollutant may be selectively exposed, e.g., by controller 102, to one or more air streams based on the first signal. For example, suppose the first signal indicates presence of particles having a particular size in a particular amount. A controller (e.g., 102) may determine whether the amount satisfies a minimum threshold. If so, the controller may expose the first air filter to one or more air streams, e.g., until the amount of particles decreases below a threshold and/or for some selected time interval.

As noted above, an air filter may be exposed to one or more air streams in various ways. At block 706a, for instance, the controller may selectively block the first air filter, e.g., using one or more louvers 212 in FIG. 2. Additionally or alternatively, the controller may selectively alter one or more air streams to pass through the first air filter. For instance, at block 706b, the controller may selectively operate one or more fans, such as a fan 314 in FIG. 3 or fan 414 in FIG. 4. Additionally or alternatively, at block 708c, the controller may selectively move all or portion of a filter assembly to expose the first filter to one or more air streams. For instance, the controller may rotate a filter assembly 404 (see FIGS. 4-5) to expose a single air filter of a set of air filters to one or more air streams.

At block 708, a second air filter adapted to target the second pollutant may be selectively exposed, e.g., by controller 102, to one or more air streams based on the second signal. For example, suppose the second signal indicates presence of formaldehyde in a particular amount. A controller (e.g., 102) may determine whether the amount of formaldehyde satisfies a minimum threshold. If so, the controller may expose the second air filter (which may be adapted to target formaldehyde) to one or more air streams. As was the case with block 706, a controller may selectively expose the second air filter to one or more air streams in various ways, including by selectively blocking the second air filter from one or more air streams (block 708a), selectively altering one or more air streams (block 708b) to pass through the second air filter, and/or by selectively moving one or more air filter assemblies (block 708c) to selectively expose the second air filter to one or more air streams. Any of the exposure operations described in relation to blocks 706 and/or 708 may be performed for one or more time intervals that are selected based on a signal from a pollutant sensor.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An air purification system comprising:
a first air filter that targets at least a first type of pollutant, wherein air that passes through the first air filter is unobstructed by other air filters;
a second air filter that targets at least a second type of pollutant that is different than the first type of pollutant, wherein air that passes through the second air filter is unobstructed by other air filters; and
a controller configured to selectively move the first and/or second air filters to expose one or both of the first and second air filters to one or more air streams.

2. The air purification system of claim 1, wherein the controller is configured to selectively block the first and second air filters from one or more air streams.

3. The air purification system of claim 2, further comprising a first set of louvers adjacent the first air filter and a second set of louvers adjacent the second air filter, wherein the controller is configured to operate the first and second sets of louvers to selectively expose the first and second air filters to one or more air streams.

4. The air purification system of claim 1, wherein the controller is further configured to selectively alter one or more air streams to selectively expose the first and second air filters to one or more air streams.

5. The air purification system of claim 4, further comprising at least one fan operably coupled with the controller, wherein the controller is configured to selectively operate the at least one fan to selectively expose the first or second air filter to one or more air streams.

6. The air purification system of claim 5, further comprising a first fan adjacent the first air filter and a second fan adjacent the second air filter, the first and second fans being operably coupled with the controller, wherein the controller is configured to selectively operate the first and second fans to selectively expose the first and second air filters to one or more air streams.

7. The air purification system of claim 1, wherein the first air filter is part of a first set of air filters forming a first filter assembly, and the second air filter is part of a second set of air filters forming a second filter assembly.

8. The air purification system of claim 7, wherein the controller is configured to move the first filter assembly to selectively expose one of the first set of air filters to an air stream.

9. The air purification system of claim 8, wherein the first set of air filters are positioned about an axis of rotation of the first filter assembly, and the controller is configured to rotate the first filter assembly about the axis of rotation to selectively expose one of the first set of air filters to the air stream.

10. The air purification system of claim 1, wherein the controller is further configured to:
track an amount of time the first air filter is exposed to one or more air streams; and
provide output notifying a user that the first air filter is near or has reached an end of its useful life based on a determination that the amount of time satisfies a threshold.

11. The air purification system of claim 1, further comprising a pollutant sensor to provide a signal indicative of a detected pollutant, wherein the controller is configured to selectively expose one or both of the first and second air filters to one or more air streams based at least in part on the signal.

12. The air purification system of claim 11, wherein the pollutant sensor is positioned downstream of the first air filter and is configured to detect presence of the second type of pollutant.

13. The air purification system according to claim 1, wherein
the first air filter comprises a first set of air filters, each adapted to detect a different pollutant, the first air filter being movable to expose a single one of the air filters of the first set of air filters to one or more air streams; and
the second air filter comprises a second set of air filters, each adapted to detect a different pollutant, the second air filter being movable to expose a single one of the air filters of the second set of air filters to one or more air streams in parallel to the single exposed air filter of the first set.

14. A method of purifying air, comprising:
selectively exposing, by a controller, a first air filter to one or more air streams to target at least a first pollutant; and
selectively exposing, by the controller, a second air filter to one or more air streams in parallel with the first filter to target at least a second pollutant that is different than the first pollutant;
wherein air that passes through the first and second air filters is unobstructed by other air filters and one or both of the first and second filters is selectively exposed by the controller to one or more air streams by moving the first and/or second air filter.
